(19) United States
(12) Patent Application Publication
(10) Pub. No.: US 2025/0069336 A1
(43) Pub. Date: Feb. 27, 2025

(54) IMAGE OPTIMIZATION METHOD AND APPARATUS FOR AUGMENTED REALITY DEVICE, ELECTRONIC DEVICE, AND SYSTEM

(71) Applicant: Goertek Inc., Weifang, Shandong (CN)

(72) Inventors: Xudong Qiu, Shandong (CN); Heliang Zou, Shandong (CN)

(73) Assignee: Goertek Inc., Weifang, Shandong (CN)

(21) Appl. No.: 18/722,035

(22) PCT Filed: Aug. 26, 2022
(86) PCT No.: PCT/CN2022/115157

§ 371 Date: Jun. 20, 2024

(30) Foreign Application Priority Data
Dec. 20, 2021 (CN) 202111562281.6

(51) Int. Cl. G06T 19/00; G06F 3/01

(52) U.S. Cl. CPC G06T 19/006; G06F 3/012

(57) ABSTRACT

The present disclosure relates to an image optimization method and apparatus for an augmented reality device, an electronic device, and a system. The method comprises: acquiring acceleration data for the augmented reality device; determining motion state information of the wearer according to the acceleration data, wherein the motion state information comprises whether the wearer is in head-turning state or a head-stationary state; acquiring a target acceleration of the augmented reality device when the wearer is in the head-turning state; compensating a to-be-displayed image of the augmented reality device according to the target acceleration.

### CROSS-REFERENCE TO RELATED APPLICATIONS

The present disclosure is a National Stage of International Application No. PCT/CN2022/115157 filed on Aug. 26, 2022, which claims priority to a Chinese patent application No. 202111562281.6 filed with the CNIPA on Dec. 20, 2021 and entitled “IMAGE OPTIMIZATION METHOD AND APPARATUS FOR AUGMENTED REALITY DEVICE, ELECTRONIC DEVICE, AND SYSTEM”, both of which are hereby incorporated by reference in their entireties.

### TECHNICAL FIELD

Embodiments of the present disclosure relates to the field of image processing for an augmented reality device, and particularly to an image optimization method and apparatus for an augmented reality device, an electronic device, and a system.

### BACKGROUND

In recent years, Augmented Reality (hereinafter referred to as AR) technology has gradually gained popularity, AR applications are increasingly welcomed by the public, with the corresponding demand for AR glasses growing day by day.

Nevertheless, there are also some problems that may arise when people are wearing AR glasses. For example, when a wearer of AR Glasses is talking with others while using AR glasses, his/her facial muscles will naturally stretch and relax, which in turn causes the AR glasses to shake up and down, such that the images in the AR glasses sway back and forth, thus severely influencing the user's experience.

Based on the above shortcomings, in order to improve the consumers' experience, image shaking caused by the wearer's talking has become a problem that demand urgent solution.

### SUMMARY

An objective of the present disclosure is to provide a new technical solution of an image optimization method and apparatus for an augmented reality device, an electronic device, and a system.

According to a first aspect of the present disclosure, an image optimization method for an augmented reality device is provided, which comprises: acquiring acceleration data for the augmented reality device; determining motion state information of a wearer of the augmented reality device according to the acceleration data, wherein the motion state information comprises whether the wearer is in head-turning state or a head-stationary state; acquiring a target acceleration of the augmented reality device when the wearer is in the head-turning state; compensating a to-be-displayed image of the augmented reality device according to the target acceleration.

Optionally, said “determining motion state information of a wearer of the augmented reality device according to the acceleration data” comprises: obtaining an actual displacement of the augmented reality device relative to an initial state according to the acceleration data; determining that the wearer is in the head-turning state when the actual displacement is greater than or equal to a preset value, and determining that the wearer is in a stationary state when the actual displacement is less than the preset value.

Optionally, said “acquiring a target acceleration of the augmented reality device when the wearer is in the head-turning state” comprises: acquiring a first acceleration in a first direction and a second acceleration in a second direction, the first acceleration being an acceleration generated when the head of the wearer turns, and the second acceleration being an acceleration in an actual movement direction of the augmented reality glasses; carrying out vector calculation on the first acceleration and the second acceleration to obtain the target acceleration.

Optionally, “carrying out vector calculation on the first acceleration and the second acceleration to obtain the target acceleration” comprises: determining the target acceleration to be zero in a case where the first acceleration and the second acceleration are equal in magnitude and are in the same direction.

Optionally, after determining motion state information of a wearer of the augmented reality device, the method further comprises: determining the acceleration data of the augmented reality device to be the target acceleration in a case where the wearer is in the head-stationary state; optimizing and compensating the to-be-displayed image of the augmented reality device according to the target acceleration.

Optionally, said “compensating a to-be-displayed image of the augmented reality device according to the target acceleration” comprises: performing an integral operation on the target acceleration to obtain a displacement value of the augmented reality device, and obtaining a displacement direction of the augmented reality device according to a direction information of the target acceleration: carrying out displacement compensation on the to-be-displayed image according to the displacement value, and carrying out direction compensation on the to-be-displayed image according to the displacement direction.

According to a second aspect of the present disclosure, an image optimization apparatus for an augmented reality device is further provided, which comprises: a data acquiring module configured for acquiring acceleration data for the augmented reality device; a data processing module configured for determining motion state information of a wearer of the augmented reality device according to the acceleration data, wherein the motion state information comprises whether the wearer is in head-turning state or a head-stationary state; an acceleration calculating module configured for acquiring a target acceleration of the augmented reality device when the wearer is in the head-turning state; a compensating module configured for compensating a to-be-displayed image of the augmented reality device according to the target acceleration.

According to a third aspect of the present disclosure, an electronic device is further provided, which comprises a memory and a processor, the memory is configured for storing a computer program: the processor is configured for executing the computer program, so as to implement the method according to any one item of the first aspect.

According to a fourth aspect of the present disclosure, an image optimization system for an augmented reality device is further provided, which comprises: augmented reality glasses configured for displaying a to-be-displayed image; an acceleration sensor fixed to the augmented reality glasses and configured for collecting acceleration data of the augmented reality glasses; a controller connected to the augmented reality glasses and the acceleration sensor and configured for executing the method according to any one of the first aspect.

According to a fifth aspect of the present disclosure, a computer-readable storage medium is further provided, the computer-readable storage medium stores a computer program therein, and the computer program, when executed by a processor, implements the method according to the first aspect.

One advantage of embodiments of the present disclosure is that by determining motion state information of a wearer of the augmented reality device according to the acceleration data, acquiring a target acceleration of the augmented reality device when the wearer is in the head-turning state, and compensating a to-be-displayed image of the augmented reality device according to the target acceleration, the method of the present embodiment can well address the image shaking issues due to shaking of the wearer during speaking, thereby improving the user's experience.

Other features of embodiments of the present disclosure and their advantages will become clear by the following detailed description of exemplary embodiments of the present disclosure with reference to the accompanying drawings.

### BRIEF DESCRIPTION OF THE DRAWINGS

The accompanying drawings, which are incorporated in the description and constitute a part of the description, illustrate embodiments of the present disclosure and, together with the description thereof, serve to explain the principles of the present disclosure.

FIG. 1 shows a flowchart of steps of an image optimization method for an augmented reality device provided in the present embodiment;

FIG. 2 shows another flowchart of steps of an image optimization method for an augmented reality device provided in the present embodiment;

FIG. 3 is a structural block diagram of a structure of an image optimization device for an augmented reality device provided in the present embodiment;

FIG. 4 is a block schematic diagram of an electronic device according to an embodiment;

FIG. 5 is a schematic diagram of a hardware structure of an image optimization system for an augmented reality device according to an embodiment;

FIG. 6 is a vector diagram for calculating a target acceleration according to an embodiment.

### DETAILED DESCRIPTION

The various exemplary embodiments of the present disclosure will now be described in detail with reference to the accompanying drawings. It should be noted that: unless otherwise specifically stated, the relative arrangement of components and steps, numerical expressions, and values set forth in these embodiments do not limit the scope of the present disclosure.

The following description of at least one exemplary embodiment is illustrative only and in no way constitutes any limitation on the present disclosure and its applications or uses.

Technologies, methods, and devices that are well known in the relevant field may not be discussed in detail, but should be considered part of the specification where appropriate.

In all examples shown and discussed here, any specific values should be interpreted as merely exemplary and not restrictive. Therefore, other examples of exemplary embodiments may have different values.

It should be noted that: similar reference numbers and letters in the following drawings represent similar items, so once an item is defined in a drawing, it does not need to be further discussed in subsequent drawings.

The application scenario of an embodiment of the present disclosure is a scenario where a user utilizes an augmented reality glasses.

During the implementation process, when the user is wearing the augmented reality glasses (hereinafter referred to as AR glasses) and conversing with others, there is an issue where the movement of facial muscles causes the image display of the augmented reality glasses to shake.

To address the technical issues present in the above embodiment, the inventor proposes an image optimization method and apparatus of the augmented reality device, an electronic device, and a system, which determines a relative acceleration of the AR glasses with respect to the wearer by detecting the acceleration of the AR glasses, obtains the acceleration of the AR glasses itself according to this relative acceleration so as to obtain a displacement of the AR glasses, and then compensates the image according to the displacement.

Below, the various embodiments and examples according to the present disclosure are described with reference to the accompanying drawings.

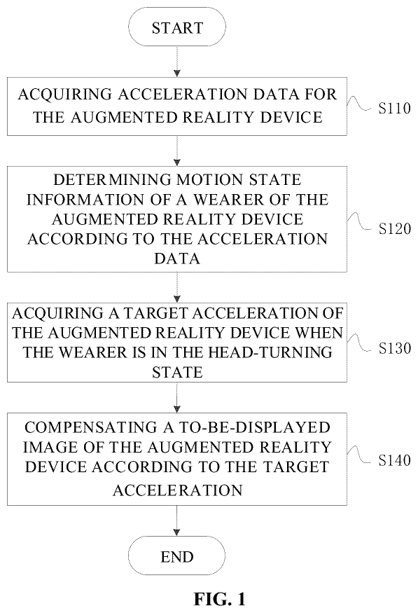

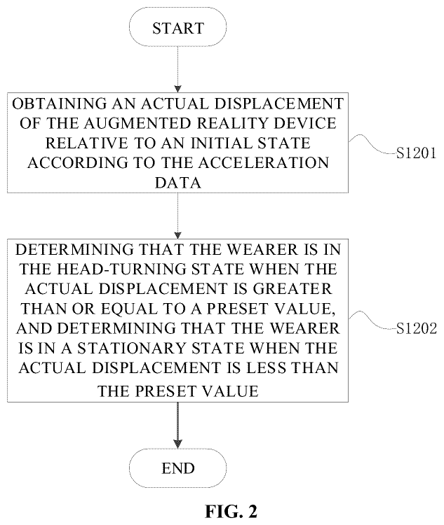

As shown in FIG. 1, the image optimization method of the augmented reality device in the present embodiment may comprise the following steps S110 to S140:

S110, acquiring acceleration data for the augmented reality device.

In the present embodiment, the augmented reality device may be an augmented display helmet or glasses, so as to provide the user with an immersive virtual experience.

In the present embodiment, to detect the acceleration of the augmented reality device, the augmented reality glasses of the present embodiment is provided with an acceleration sensor, that is, the acceleration data in the present embodiment is collected by the acceleration sensor of the augmented reality device.

In one example, the acceleration sensor may be a three-axis acceleration sensor, which may be positioned at the center of the augmented reality device. In the present embodiment, taking the AR glasses as an example of the augmented reality device, the acceleration sensor may be positioned in the middle between the two lenses of the AR glasses to obtain more accurate acceleration data.

It is understood that the acceleration is a vector, meaning that the acceleration data has both magnitude and direction. In the present embodiment, the acceleration data may comprise acceleration values in a plurality of directions, meaning that the acceleration data may comprise both overall acceleration values and acceleration components in a plurality of directions.

S120, determining motion state information of a wearer of the augmented reality device according to the acceleration data.

In some scenarios, when the wearer is using the AR glasses to talk with people around him/her, he/she may be stationary, such as when the wearer is standing still and watching images: the wearer may also be in motion, such as when the wearer is moving or shaking head following the virtual scenes in the AR glasses.

It is understood that when the wearer is conversing with people around him/her and is stationary, the augmented reality device shakes with the wearer's speech, meaning that the augmented reality device and the wearer are in a relatively shaking state, and the acceleration data collected by the acceleration sensor is the acceleration caused by the relaxation of the speaker's face.

However, when the wearer is conversing with people around him/her and is in motion, the acceleration data collected by the acceleration sensor is the sum of the acceleration brought about by the relaxation of the speaker's face and his/her own movement. That is to say, the acceleration data collected by the acceleration sensor cannot directly represent the relative acceleration between the augmented reality device and the wearer.

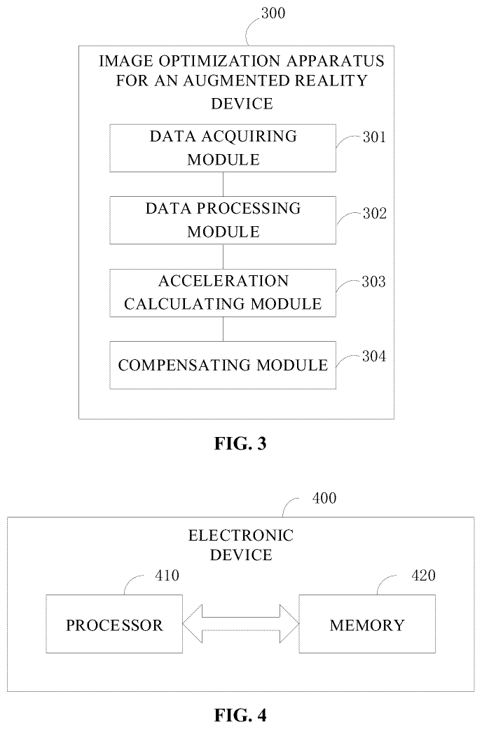

The present embodiment takes the acceleration data as a basis for analysis and calculation to determine the motion state information of the wearer of the augmented reality device. Specifically, with reference to FIG. 3, it comprises:

S1201, obtaining an actual displacement of the augmented reality device relative to an initial state according to the acceleration data.

In one example, the acceleration is the changing rate of a velocity, and the velocity is the changing rate of the displacement. That is, the acceleration is the derivative of the velocity, the velocity is the derivative of the displacement, and therefore the acceleration is the second derivative of the displacement. Then, the integral of the acceleration is the velocity, the integral of the velocity is the displacement, and thus the displacement may be obtained by performing second-order integration on the acceleration, that is to perform integration on the target acceleration, then the actual displacement value of the augmented reality device is obtained. It should be noted that when calculating the actual displacement of the augmented reality device relative to the initial state, it is calculated through the resultant acceleration of the augmented reality device.

S1202, determining that the wearer is in the head-turning state when the actual displacement is greater than or equal to a preset value, and determining that the wearer is in a stationary state when the actual displacement is less than the preset value.

In one example, considering the limited size of the facial features, the displacement of the augmented device brought about by speaking or facial shaking is limited. Therefore, the present embodiment sets a preset value and determines the motion state information of the wearer by comparing the actual displacement with the size of the preset value. This preset value may be defined by a system, or may be customized according to requirements.

In the present embodiment, when the actual displacement is greater than or equal to the preset value, it indicates that the displacement value of the augmented reality device at this time is too large, and it is determined that the wearer is in the head-turning state. When the actual displacement is less than the preset value, even though this may be caused by the slight turning of the wearer's head, since this displacement is equivalent to the displacement caused by the shaking of the wearer's face, the influence thereof is small and negligible, and therefore, it is determined that the wearer is in a stationary state at this time.

S130, acquiring a target acceleration of the augmented reality device when the wearer is in the head-turning state.

It is understood that when the wearer is turning head and speaking, the acceleration thereof is composed of accelerations in a plurality of directions. Therefore, in the present embodiment, when the wearer is in the head-turning state, acquiring the target acceleration of the augmented reality device by acquiring a first acceleration in a first direction and a second acceleration in a second direction, specifically comprises: acquiring a first acceleration in a first direction and a second acceleration in a second direction, wherein the first acceleration is the acceleration produced by turning of the wearer's head, and the second acceleration is the acceleration in the actual motion direction of the augmented reality glasses; then carrying out vector calculation on the first and second accelerations to obtain the target acceleration, which is the acceleration brought about by the wearer's speech or other facial movements.

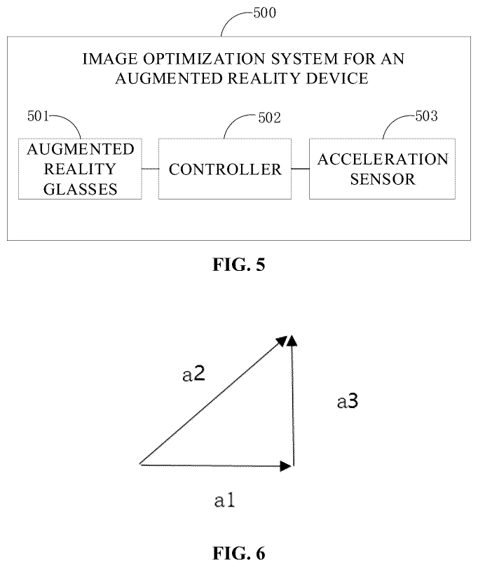

Refer to FIG. 6, it illustrates the vector calculation of the target acceleration. Considering that acceleration is a vector that includes direction and magnitude, the second acceleration a2 is vector-subtracted from the first acceleration a1, deriving the target acceleration a3=a2−a1. It is understood that the target acceleration is the acceleration brought about by the wearer's speech or other facial movements, and the displacement caused by this target acceleration is the offset of the augmented reality device relative to the wearer. Compensation may thus be made to the to-be-displayed image of the augmented reality device based on the target acceleration.

In one example, since the first acceleration is the acceleration produced by the turning of the wearer's head and the second acceleration is the acceleration in the actual motion direction of the augmented reality device, and when the first and second accelerations are equal in magnitude and in the same direction, it indicates that the actual acceleration of the augmented reality device is entirely due to the turning of the wearer's head. It can be assumed that the wearer at this time is only in a state of turning the head thereof with no acceleration caused by facial tremors, meaning that no facial tremors have occurred, and the target acceleration may be determined to be zero, and consequently, there is no need to compensate the to-be-displayed image.

In one example, after determining the motion state information of the wearer of the augmented reality device, if the wearer is in the head-stationary state, the augmented reality device will shake along with the wearer's speech, meaning that the augmented reality device and the wearer are in a relatively shaking state, and the acceleration data collected by the acceleration sensor is the acceleration caused by the relaxation of the speaker's face. That is to say, when the wearer is in the head-stationary state, the acceleration data of the augmented reality device is determined to be the target acceleration, and the to-be-displayed image of the augmented reality device is optimized and compensated according to this target acceleration.

S140, compensating a to-be-displayed image of the augmented reality device according to the target acceleration.

Specifically, in the present embodiment, the displacement value of the augmented reality device is obtained by integrating the target acceleration, and the displacement direction of the augmented reality device is obtained according to the directional information of the target acceleration: the to-be-displayed image is subjected to displacement compensation according to the displacement value, and the to-be-displayed image is subjected to direction compensation according to the displacement direction.

In one example, the acceleration is the changing rate of the velocity, and the velocity is the changing rate of the displacement. That is, the acceleration is the derivative of the velocity, the velocity is the derivative of the displacement, and thus the acceleration is the second derivative of the displacement. Thus, the integral of the acceleration is the velocity, the integral of the velocity is the displacement, and thus the displacement may be obtained by integrating the acceleration twice. That is, the displacement value of the augmented reality device is obtained by integrating the target acceleration.

Since the acceleration is a vector, the displacement direction of the augmented reality device may be obtained based on the directional information of the target acceleration. Wherein, taking the augmented reality device and the wearer in a relatively static state as an example, when the wearer opens his or her mouth, the augmented reality device will move upward, meaning the acceleration direction is upward, and the augmented reality device also moves upward. Therefore, the displacement direction of the augmented reality device is consistent with the displacement direction of the target acceleration, and the displacement amount of the augmented reality device is the displacement value obtained according to the target acceleration.

Thus, the displacement amount of the augmented reality device may be obtained according to the displacement value and displacement direction. The displacement amount is a vector that is consistent in magnitude with the displacement value and is consistent with the displacement direction.

It is understood that in order to keep the displayed virtual image always directly in front of the wearer's eyes, that is, to keep the displayed image relatively stable with respect to the wearer's eyes, the to-be-displayed image needs to be in the opposite direction of the actual movement of the augmented reality glasses. For example: the augmented reality device shakes upward by a displacement value S, then the corresponding to-be-displayed image is moved downward by S for compensation: similarly, when the augmented reality device shakes downward by a displacement value S, then the corresponding to-be-displayed image is moved upward by S for compensation.

According to the above steps S110 to S140, it can be known that by determining motion state information of a wearer of the augmented reality device according to the acceleration data, acquiring a target acceleration of the augmented reality device when the wearer is in the head-turning state, and compensating a to-be-displayed image of the augmented reality device according to the target acceleration, the method of the present embodiment can well address the image shaking issues due to shaking of the wearer during speaking, thereby improving the user's experience.

### Device Embodiments

FIG. 3 is a block schematic diagram of an apparatus according to an embodiment. As shown in FIG. 3, the image optimization apparatus of the augmented reality device 300 may comprise:
a data acquiring module 301 configured for acquiring acceleration data for the augmented reality device;
a data processing module 302 configured for determining motion state information of a wearer of the augmented reality device according to the acceleration data, wherein the motion state information comprises that the wearer is in head-turning state or a head-stationary state;
an acceleration calculating module 303 configured for acquiring a target acceleration of the augmented reality device when the wearer is in the head-turning state;
a compensating module 304 configured for compensating a to-be-displayed image of the augmented reality device according to the target acceleration.

In one embodiment, the data processing module 302 may be configured for obtaining an actual displacement of the augmented reality device relative to an initial state according to the acceleration data: determining that the wearer is in the head-turning state when the actual displacement is greater than or equal to a preset value, and determining that the wearer is in a stationary state when the actual displacement is less than the preset value.

In one embodiment, the acceleration calculating module 303 may be configured for acquiring a first acceleration in a first direction and a second acceleration in a second direction, the first acceleration being an acceleration generated when the head of the wearer turns, and the second acceleration being an acceleration in an actual movement direction of the augmented reality glasses; carrying out vector calculation on the first acceleration and the second acceleration to obtain the target acceleration.

In one embodiment, the acceleration calculating module 303 may be configured for determining the target acceleration to be zero in a case where the first acceleration and the second acceleration are equal in magnitude and are in the same direction.

In one embodiment, the acceleration calculating module 303 may be configured for determining the acceleration data of the augmented reality device to be the target acceleration in a case where the wearer is in the head-stationary state.

In one embodiment, the compensating module 304 is configured for performing an integral operation on the target acceleration to obtain a displacement value of the augmented reality device, and obtaining a displacement direction of the augmented reality device according to a direction information of the target acceleration; carrying out displacement compensation on the to-be-displayed image according to the displacement value, and carrying out direction compensation on the to-be-displayed image according to the displacement direction.

By determining motion state information of a wearer of the augmented reality device according to the acceleration data, acquiring a target acceleration of the augmented reality device when the wearer is in the head-turning state, and compensating a to-be-displayed image of the augmented reality device according to the target acceleration, the present embodiment can well address the image shaking issues due to shaking of the wearer during speaking, thereby improving the user's experience.

FIG. 4 is a schematic diagram of a hardware structure of an electronic device according to another embodiment.

As shown in FIG. 4, the electronic device 400 comprises a memory 410 and a processor 420, and the memory 420 is configured for storing a computer program: the processor 410 is configured for executing the method such as any of the above method embodiments according to the control of the computer program.

The modules of the above electronic device 400 may be realized by the processor 410 in the present embodiment executing the computer program stored in the memory 410, or may be realized by other circuit structures, which are not limited herein.

By obtaining different relative motion states of the augmented display device and the wearer according to the duration of the acceleration data of the augmented reality device at a stabilized value in order to obtain the corresponding target acceleration, and compensating the to-be-displayed image according to the target acceleration, the present embodiment can well address the image shaking issues due to shaking of the wearer during speaking, thereby improving the user's experience.

The present embodiment further provides an image optimization system 500 for an augmented reality device. As shown in FIG. 5, the system comprises:
augmented reality glasses 501 configured for displaying a to-be-displayed image;
an acceleration sensor 503 fixed to the augmented reality glasses and configured for collecting acceleration data of the augmented reality glasses;
a controller 503 connected to the augmented reality glasses and the acceleration sensor and configured for executing the image optimization method of the augmented reality device.

By determining motion state information of a wearer of the augmented reality device according to the acceleration data, acquiring a target acceleration of the augmented reality device when the wearer is in the head-turning state, and compensating a to-be-displayed image of the augmented reality device according to the target acceleration, the present embodiment can well address the image shaking issues due to shaking of the wearer during speaking, thereby improving the user's experience.

The present embodiment further provides a computer-readable storage medium, the computer-readable storage medium storing a computer program therein, and the computer program, when executed by a processor, implements the image optimization method of the augmented reality device.

The present disclosure may be a system, a method, and/or a computer program product. The computer program product may include a computer readable storage medium (or media) having computer readable program instructions thereon for causing a processor to carry out aspects of the present disclosure.

The computer readable storage medium may be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein may be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, comprising an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, comprising a local area network (LAN) or a wide area network (WAN), or the connection may be made to an external computer (for example, through the Internet using an Internet Service Provider). In some embodiments, electronic circuitry comprising, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, may be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture comprising instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, may be implemented by special purpose hardware-based systems that perform the specified functions or acts, or combinations of special purpose hardware and computer instructions. It is well-known to a person skilled in the art that the implementations of using hardware, using software or using the combination of software and hardware may be equivalent.

Embodiments of the present disclosure have been presented for purposes of illustration, but are not intended to be exhaustive or limited to the embodiments disclosed. Numerous modifications and changes will be apparent to those skilled in the art without departing from the scope and spirit of the illustrated embodiments. The terminology used herein was chosen to best explain the principles of the embodiments, the practical application or technical improvement over technologies found in the marketplace, or to enable others of ordinary skill in the art to understand the embodiments disclosed herein. The scope of the present disclosure is defined by the appended claims.

1. An image optimization method for an augmented reality device worn by a wearer, wherein the method comprises:
acquiring acceleration data for the augmented reality device;
determining motion state information of the wearer according to the acceleration data, wherein the motion state information comprises whether the wearer is in a head-turning state or a head-stationary state;
acquiring a target acceleration of the augmented reality device when the wearer is in the head-turning state; and
compensating a to-be-displayed image of the augmented reality device according to the target acceleration.

2. The method according to claim 1, wherein said determining motion state information of the wearer according to the acceleration data comprises:
obtaining an actual displacement of the augmented reality device relative to an initial state according to the acceleration data; and
determining that the wearer is in the head-turning state when the actual displacement is greater than or equal to a preset value, and determining that the wearer is in a stationary state when the actual displacement is less than the preset value.

3. The method according to claim 1, wherein said “acquiring a target acceleration of the augmented reality device when the wearer is in the head-turning state” comprises:
acquiring a first acceleration in a first direction and a second acceleration in a second direction, the first acceleration being an acceleration generated when the head of the wearer turns, and the second acceleration being an acceleration in an actual movement direction of the augmented reality device; and
performing vector calculation on the first acceleration and the second acceleration to obtain the target acceleration.

4. The method according to claim 3, wherein said performing vector calculation on the first acceleration and the second acceleration to obtain the target acceleration comprises:
determining the target acceleration to be zero in a case where the first acceleration and the second acceleration are equal in magnitude and are in the same direction.

5. The method according to claim 1, wherein after determining motion state information of the wearer, the method further comprises:
determining the acceleration data of the augmented reality device to be the value of the target acceleration when the wearer is in the head-stationary state.

6. The method according to claim 1, wherein said compensating a to-be-displayed image of the augmented reality device according to the target acceleration comprises:
performing an integral operation on the target acceleration to obtain a displacement value of the augmented reality device, and obtaining a displacement direction of the augmented reality device according to direction information of the target acceleration; and
performing displacement compensation on the to-be-displayed image according to the displacement value and displacement direction.

7. An image optimization apparatus for an augmented reality device adapted to be worn by a wearer, wherein the apparatus comprises:
a data acquiring module configured for acquiring acceleration data for the augmented reality device;
a data processing module configured for determining motion state information of the wearer according to the acceleration data, wherein the motion state information comprises whether the wearer is in a head-turning state or a head-stationary state;
an acceleration calculating module configured for acquiring a target acceleration of the augmented reality device when the wearer is in the head-turning state; and
a compensating module configured for compensating a to-be-displayed image of the augmented reality device according to the target acceleration.

8. An electronic device comprising a memory and a processor, wherein the memory is configured for storing a computer program and the processor is configured for executing the computer program, so as to implement the method according to claim 1.

9. An image optimization system for an augmented reality device, wherein the system comprises:
an augmented reality device configured for displaying a to-be-displayed image;
an acceleration sensor fixed to the augmented reality device, and configured for collecting acceleration data of the augmented reality device;
a controller connected to the augmented reality device and the acceleration sensor, and configured for executing the method according to claim 1.

10. A computer-readable storage medium device, wherein the computer-readable storage medium device is adapted for storing a computer program therein, wherein said computer program, when executed by a processor, is configured for implementing the method according to claim 1.
